(19) United States
(12) Patent Application Publication
(10) Pub. No.: US 2022/0349367 A1
(43) Pub. Date: Nov. 3, 2022

(54) AIR CLEANER DEVICE

(71) Applicant: Isuzu Motors Limited, Tokyo (JP)

(72) Inventor: Junichi TABETA, Fujisawa-shi, Kanagawa (JP)

(73) Assignee: Isuzu Motors Limited, Tokyo (JP)

(21) Appl. No.: 17/622,245

(22) PCT Filed: Jun. 26, 2020
(86) PCT No.: PCT/JP2020/025202

§ 371 Date: Dec. 23, 2021

(30) Foreign Application Priority Data
Jun. 28, 2019 (JP) 2019-121124

(51) Int. Cl. F02M 35/022; F02M 35/024; F02M 35/08

(52) U.S. Cl. CPC F02M 35/022; F02M 35/02416; F02M 35/08

(57) ABSTRACT

This air cleaner device is capable of preventing liquid, in the air that has been sucked in, from escaping to the downstream side of a filter element. The air cleaner device is provided in an intake passage of an internal combustion engine, and comprises: the filter element for removing foreign matter contained in the air that has been sucked into the intake passage; and a collision/separation part which is disposed on a surface of the filter element such that the liquid is separated from the air as a result of the air colliding with the collision/separation part, on the upstream side of the filter element in the suction direction of the air.

### TECHNICAL FIELD

The present disclosure relates to an air cleaner device.

### BACKGROUND ART

An air cleaner device that removes, by a filter element (e.g., a filter paper), fine foreign matter (e.g., trash and dust) contained in the air suctioned from the outside of a vehicle has been known as a device provided in an intake passage of an internal combustion engine (e.g., a diesel engine) of a vehicle (e.g., a truck and bus) (see, e.g., Patent Literature (hereinafter, referred to as “PTL”)1).

The air cleaner device includes a filter element for removing foreign matter in the air suctioned into the intake passage and a housing for storing the filter element. The housing includes an intake inlet for taking air into the housing and an intake outlet for discharging the air from which foreign matter has been removed by the filter element toward the internal combustion engine.

### CITATION LIST

### Patent Literature

PTL 1

Japanese Patent Application Laid-Open No. 2012-207540

### SUMMARY OF INVENTION

### Technical Problem

However, the conventional air cleaner device is configured to remove foreign matter in the air taken from the intake inlet directly by the filter element. For this reason, there arises a problem in that, when the intake air contains liquid (e.g., water), the liquid contacts with the filter element, easily passing through the filter element, and flows into the downstream side (an internal combustion engine). This may damage the internal combustion engine.

An object of the present disclosure is to provide an air cleaner device that can prevent liquid in the intake air from flowing into the downstream side of the filter element.

### Solution to Problem

An air cleaner device according to the present disclosure is an air cleaner device provided in an intake passage of an internal combustion engine,

the air cleaner device including: a filter element that removes foreign matter contained in the air suctioned into the intake passage; and

a collision separation section that is provided on or adjacent to the surface of the filter element so that liquid is separated from the air by the air colliding with the collision separation section on the upstream side of the filter element in the intake direction of the air.

### Advantageous Effects of Invention

According to the present disclosure, it is possible to prevent liquid contained in the intake air from flowing into the downstream side of the filter element.

### BRIEF DESCRIPTION OF DRAWINGS

FIG. 1 is a cross-sectional view of a configuration of an air cleaner device in an embodiment; and

FIG. 2 is a perspective view of a part of the configuration of the air cleaner device in the embodiment.

### DESCRIPTION OF EMBODIMENTS

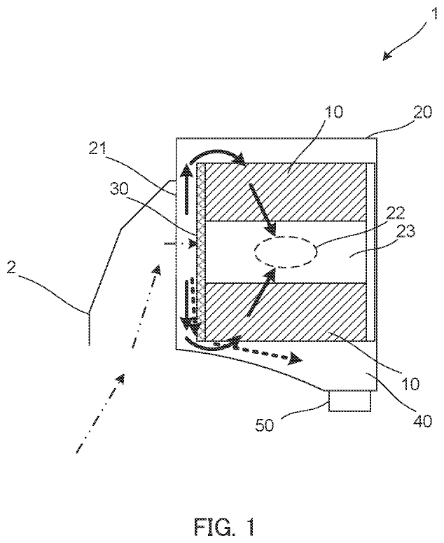

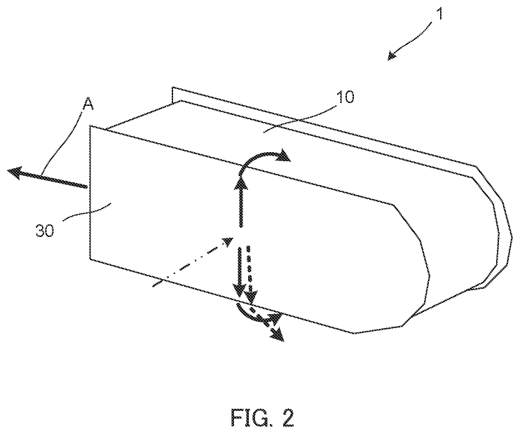

Hereinafter, an embodiment will be described in detail with reference to the drawings. FIG. 1 is a cross-sectional view of a configuration of an air cleaner device in the embodiment, and FIG. 2 is a perspective view of a part of the configuration of the air cleaner device in the embodiment.

As shown in FIG. 1, air cleaner device 1 is provided in the intake passage of an internal combustion engine (e.g., a diesel engine) of a vehicle (e.g., a truck and bus) and connected to intake duct 2 above the radiator (not shown). The air outside the vehicle is suctioned into intake duct 2 through an inlet port (not shown) provided on the front side of the vehicle.

Air cleaner device 1 includes filter element 10 that removes fine foreign matter (e.g., trash and dust) contained in the air suctioned into intake duct 2, and housing 20 (functioning as a “housing unit” in the present disclosure) that stores filter element 10.

Filter element 10 has a U-shape in which the opening is formed toward the depth side in the direction perpendicular to the sheet surface of FIG. 1, i.e., the direction of the arrow A in FIG. 2. Filter element 10 is made of a filter material, which is, for example, a cloth, paper, or nonwoven cloth, and formed in a pleated shape having a continuous zigzag shape.

Housing 20 includes intake inlet 21 that takes the air suctioned from intake duct 2 into housing 20, and intake outlet 22 that discharges the air from which foreign matter has been removed by filter element 10 toward the internal combustion engine.

Intake outlet 22 communicates with space 23 that is partitioned by filter element 10 on the upper and lower sides.

On the surface of filter element 10 (the left surface in FIG. 1), collision separation wall 30 (functioning as a “collision separation section” in the present disclosure) is provided so that the air collides with collision separation wall 30 on the upstream side of filter element 10 in the intake direction of air to separate moisture (liquid) from the air. Note that filter element 10 and collision separation wall 30 may be formed integrally or separately.

Collision separation wall 30 is made of a resin member, for example, and has a wall surface having water resistance. The vertical length of collision separation wall 30 is the same as the vertical length of filter element 10. The two-dot chain line arrows in FIGS. 1 and 2 indicate the flow of the air (including moisture) suctioned into intake duct 2. As shown in FIG. 1, housing 20 stores filter element 10 so that intake inlet 21 and collision separation wall 30 face each other.

Collision of the air with collision separation wall 30 on the upstream side of filter element 10 separates moisture from the air, and the moisture falls downward along the surface of collision separation wall 30. The dotted arrows in FIGS. 1 and 2 indicate the flow of the moisture separated from the air that has collided with collision separation wall 30.

The air from which the moisture has been separated by the collision with collision separation wall 30 flows upward and downward along the wall surface of collision separation wall 30 and then enters into filter element 10 from the upper and lower sides of filter element 10. That is, housing 20 stores filter element 10 so that the air from which the moisture has been separated enters into filter element 10 from the upper and lower sides of filter element 10. According to the present disclosure, the wall surface of collision separation wall 30 and the filter surface of filter element 10 are at right angles (90 degrees) to each other. Note that the air from which the moisture has been separated by the collision with collision separation wall 30 may flow upward or downward along the wall surface of collision separation wall 30 and then enter into filter element 10 from above or below filter element 10.

The air having entered filter element 10 is discharged toward the internal combustion engine through space 23 and intake outlet 22 after fine foreign matter is removed. Solid line arrows in FIGS. 1 and 2 indicate the flow of the air from which moisture has been separated.

According to the present embodiment, storage section 40 and exhaust valve 50 are provided under filter element 10 and collision separation wall 30.

Storage section 40 stores the water that has been separated and has fallen from the air by the collision with collision separation wall 30. As shown in FIG. 1, the bottom of storage section 40 is configured to be lowered gradually from the left to the right side.

Exhaust valve 50 is provided at the lowest part of the bottom of storage section 40 to discharge the water stored in storage section 40 to the outside of housing 20. For example, when the amount of the water stored in storage section 40 is less than a certain amount, exhaust valve 50 is closed, whereas when the amount of the water stored in storage section 40 is more than the certain amount, exhaust valve is opened. This can prevent the water from being contained in the air and entering (that is, watering) into filter element 10 when the amount of the water stored in storage section 40 increases.

As described in detail above, air cleaner device 1 of the present disclosure includes filter element 10 that removes foreign matter contained in the air suctioned into the intake passage of the internal combustion engine, and collision separation wall 30 (collision separation section) provided on the surface of filter element 10 so that liquid (moisture) is separated from the air by the air colliding with collision separation wall 30 on the upstream side of filter element 10 in the intake direction.

According to the present embodiment as described above, when the air taken from intake inlet 21 of housing 20 contains moisture, the moisture is separated from the air by the air colliding with collision separation wall 30 on the upstream side of filter element 10 in the intake direction of the air. This prevents the moisture contained in the air from flowing into the downstream side (an internal combustion engine) through filter element 10 to result in damaging the internal combustion engine.

Further, in the present embodiment, moisture can be separated from the air by such a simple configuration in which collision separation wall 30 is provided on the surface of the filter element 10. This can achieve cost reduction and space saving as compared with the case where a structure to prevent filter element 10 from being watered is separately provided in housing 20.

In addition, in the present embodiment, housing 20 houses filter element 10 so that intake inlet 21 and collision separation wall 30 face each other. This configuration makes sure for the air to collide with collision separation wall 30 and to separate moisture from the air.

Moreover, in the present embodiment, storage section 40 for storing the water that has been separated and has fallen from the air is provided under filter element 10 and collision separation wall 30. This configuration can store the water that has been separated from the air apart from filter element 10 and collision separation wall 30, and thus can prevent the water that has been separated from the air from being re-contained in the air and entering (that is, watering) into filter element 10.

Also, in the present embodiment, air cleaner device 1 includes exhaust valve 50 that discharges the water stored in storage section 40 to the outside of air cleaner device 1. With this configuration, when the amount of the water stored in storage section 40 is more than a certain amount, exhaust valve 50 is opened to discharge the water to the outside of housing 20. This can prevent the water from being contained in the air and entering (that is, watering) into filter element 10 when the amount of the water stored in storage section 40 increases.

The embodiment described above merely describes an example of implementations for practicing the present disclosure, and should not be construed as limiting the technical scope of the present disclosure. That is, the present disclosure can be implemented in various forms without departing from the spirit or principal features of the present disclosure.

The present application is based on Japanese Patent Application No. 2019-121124 filed on Jun. 28, 2019, the contents of which are incorporated herein by reference.

### INDUSTRIAL APPLICABILITY

The present disclosure is useful as an air cleaner device that can prevent liquid contained in intake air from flowing into the downstream side.

### REFERENCE SIGNS LIST

1 Air cleaner device
2 Intake duct
10 Filter element
20 Housing
21 Intake inlet
22 Intake outlet
23 Space
30 Collision separation wall
40 Storage section
50 Exhaust valve

What is claimed is:

1. An air cleaner device provided in an intake passage of an internal combustion engine, the air cleaner device comprising:
a filter element that removes foreign matter contained in an air suctioned into the intake passage; and
a collision separation section that is provided on or adjacent to a surface of the filter element so that liquid is separated from the air by the air colliding with the collision separation section on an upstream side of the filter element in an intake direction of the air.

2. The air cleaner device according to claim 1, comprising a housing unit that houses the filter element, wherein
the housing unit includes an intake inlet for taking the air into the housing unit and stores the filter element in the housing unit so that the intake inlet and the collision separation section face each other.

3. The air cleaner device according to claim 2, wherein
the housing unit houses the filter element so that the air from which the liquid has been separated enters into the filter element from at least one of an upper side and/or a lower side of the filter element.

4. The air cleaner device according to claim 2, wherein
the housing unit includes a storage section for storing the liquid that has been separated from the air.

5. The air cleaner device according to claim 4, wherein
the storage section is provided under the filter element and the collision separation section and stores the liquid that has been separated and has fallen from the air.

6. The air cleaner device according to claim 4, comprising an exhaust valve that discharges the liquid stored in the storage section to an outside of the housing unit.
